(19) United States
(12) Patent Application Publication
(10) Pub. No.: US 2025/0039447 A1
(43) Pub. Date: Jan. 30, 2025

(54) DECODING METHOD, ENCODING METHOD, DECODING DEVICE, AND ENCODING DEVICE

(71) Applicant: Panasonic Intellectual Property Corporation of America, Torrance, CA (US)

(72) Inventors: Masato OHKAWA, Toyama (JP); Noritaka IGUCHI, Osaka (JP); Toshiyasu SUGIO, Osaka (JP); Takahiro NISHI, Nara (JP)

(21) Appl. No.: 18/917,242

(22) Filed: Oct. 16, 2024

Related U.S. Application Data
(63) Continuation of application No. PCT/JP2023/014228, filed on Apr. 6, 2023.
(60) Provisional application No. 63/333,686, filed on Apr. 22, 2022.

(51) Int. Cl. H04N 19/597; H04N 19/70

(52) U.S. Cl. CPC H04N 19/597; H04N 19/70

(57) ABSTRACT

A decoding method includes: receiving control information; and decoding first attribute information on a first attribute of a three-dimensional point, according to the control information received. The control information received indicates that the first attribute depends on a second attribute of the three-dimensional point.

### CROSS REFERENCE TO RELATED APPLICATIONS

This application is a U.S. continuation application of PCT International Patent Application Number PCT/JP2023/014228 filed on Apr. 6, 2023, claiming the benefit of priority of U.S. Provisional Patent Application No. 63/333,686 filed on Apr. 22, 2022, the entire contents of which are hereby incorporated by reference.

### FIELD

The present disclosure relates to a decoding method, an encoding method, a decoding device, and an encoding device.

### BACKGROUND

Devices or services utilizing three-dimensional data are expected to find their widespread use in a wide range of fields, such as computer vision that enables autonomous operations of cars or robots, map information, monitoring, infrastructure inspection, and video distribution. Three-dimensional data is obtained through various means including a distance sensor such as a rangefinder, as well as a stereo camera and a combination of a plurality of monocular cameras.

Methods of representing three-dimensional data include a method known as a point cloud scheme that represents the shape of a three-dimensional structure by a point cloud in a three-dimensional space. In the point cloud scheme, the positions and colors of a point cloud are stored. While point cloud is expected to be a mainstream method of representing three-dimensional data, a massive amount of data of a point cloud necessitates compression of the amount of three-dimensional data by encoding for accumulation and transmission, as in the case of a two-dimensional moving picture (examples include Moving Picture Experts Group-4 Advanced Video Coding (MPEG-4 AVC) and High Efficiency Video Coding (HEVC) standardized by MPEG).

Meanwhile, point cloud compression is partially supported by, for example, an open-source library (Point Cloud Library) for point cloud-related processing.

Furthermore, a technique for searching for and displaying a facility located in the surroundings of the vehicle by using three-dimensional map data is known (see, for example, Patent Literature (PTL) 1).

### CITATION LIST

### Patent Literature

PTL 1: International Publication WO 2014/020663

### SUMMARY

### Technical Problem

In the encoding processing and decoding processing of three-dimensional data, there is a demand for reducing the data amount of encoded data.

The present disclosure provides a decoding method, an encoding method, a decoding device, or an encoding device capable of reducing the data amount of encoded data.

### Solution to Problem

A decoding method according to an aspect of the present disclosure includes: receiving control information; and decoding first attribute information on a first attribute of a three-dimensional point, according to the control information received, wherein the control information received indicates that the first attribute depends on a second attribute of the three-dimensional point.

An encoding method according to an aspect of the present disclosure includes: encoding first attribute information on a first attribute of a three-dimensional point; and transmitting the first attribute information encoded and control information, wherein the control information indicates that the first attribute depends on a second attribute of the three-dimensional point.

### Advantageous Effects

The present disclosure can provide a decoding method, an encoding method, a decoding device, or an encoding device capable of reducing the data amount of encoded data.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an example configuration of point cloud data according to an embodiment.

FIG. 2 is a block diagram illustrating the configuration of a three-dimensional data encoding device according to the embodiment.

FIG. 3 is a block diagram illustrating the configuration of a three-dimensional data decoding device according to the embodiment.

FIG. 4 is a diagram illustrating an example of information inputted to/outputted from an attribute information converter according to the embodiment.

FIG. 5 is a diagram illustrating an example of a syntax of an SPS according to the embodiment.

FIG. 6 is a diagram illustrating an example of a syntax of attribute_parameter according to the embodiment.

FIG. 7 is a diagram illustrating the configuration of a bitstream according to the embodiment.

FIG. 8 is a diagram illustrating the configuration of an attribute component according to the embodiment.

FIG. 9 is a diagram illustrating an example of information stored in an SPS according to the embodiment.

FIG. 10 is a diagram illustrating an example of information stored in an SPS according to the embodiment.

FIG. 11 is a block diagram illustrating the configuration of an attribute information encoder according to the embodiment.

FIG. 12 is a block diagram illustrating the configuration of an attribute information decoder according to the embodiment.

FIG. 13 is a diagram illustrating an example of a syntax of attribute_parameter according to the embodiment.

FIG. 14 is a flowchart of encoding processing of attribute information according to the embodiment.

FIG. 15 is a flowchart of decoding processing of attribute information according to the embodiment.

FIG. 16 is a diagram illustrating an example of a syntax of frame_attr_param_SEI according to the embodiment.

FIG. 17 is a diagram illustrating an example of a syntax of angle_partial_access_SEI according to the embodiment.

FIG. 18 is a flowchart of decoding processing when performing partial decoding according to the embodiment.

FIG. 19 is a flowchart of three-dimensional data decoding processing according to the embodiment.

FIG. 20 is a flowchart of three-dimensional data encoding processing according to the embodiment.

### DESCRIPTION OF EMBODIMENTS

A decoding method according to an aspect of the present disclosure includes: receiving control information; and decoding first attribute information on a first attribute of a three-dimensional point, according to the control information received. The control information received indicates that the first attribute depends on a second attribute of the three-dimensional point. Because the first attribute depends on the second attribute, it may be possible to reduce the data amount of the first attribute information. A decoding device can appropriately decode encoded data for which the data amount has been reduced in the above manner, using the control information. Furthermore, the amount of data to be handled in the decoding device can be reduced.

For example, the control information may indicate that the first attribute information is a difference between the first attribute and the second attribute. Because the first attribute information is the difference between the first attribute and the second attribute, it may be possible to reduce the data amount of the first attribute information. For example, when a plurality of colors are associated with the three-dimensional point as attributes, depending on the region in which the three-dimensional point is present, the plurality of colors become approximately the same. In this case, depending on the region, the first attribute information becomes a value that is close to 0, and the data amount is reduced. Therefore, control information may be provided for each region.

For example, the control information may include at least one of offset information or scales information to be applied to the difference. By performing conversion using at least one of the offset information or the scales information, it may be possible to reduce the data amount of the first attribute information. For example, when the first attribute and the second attribute satisfy a linear function relationship, the value of the first attribute information becomes a value that is close to 0.

For example, the at least one of the offset information or the scales information may be provided separately to each of a plurality of attribute information of the three-dimensional point. Accordingly, since the at least one of the offset information or the scales information can be set for each attribute, the data amount of the first attribute information can be reduced.

For example, the first attribute information may be contained in a first component different from a second component in which second attribute information on the second attribute is contained.

For example, a first number of dimensions representing the first component may be different from a second number of dimensions representing the second component. Accordingly, even when the number of dimensions of the first attribute and the second attribute are different, the data amount of the first attribute information can be reduced.

For example, the first attribute information and the second attribute information may indicate a first color and a second color of the three-dimensional point, respectively, and the first color and the second color may each be represented by a plurality of dimensions. Accordingly, by making use of the dependence relationship between the colors of the three-dimensional point which may be correlated, the data amount can be reduced.

For example, the first attribute information and the second attribute information may indicate a color and a reflectance of the three-dimensional point, respectively, and a first number of dimensions representing the color may be three and a second number of dimensions representing the reflectance may be one. Accordingly, by making use of the dependence relationship between the color and the reflectance which may be correlated, the data amount can be reduced. For example, when the reflectance is substantially equal to the smallest value, the color of the three-dimensional point having such reflectance is close to black, and when the reflectance is substantially equal to the largest value, the color of the three-dimensional point having such reflectance is close to white. In view of this, by establishing beforehand between the encoding device and the decoding device an agreement that the first attribute information is to be decoded into information indicating black or white depending on the reflectance, it may be possible to reduce the data amount of the first attribute information.

Furthermore, since positions with a reflectance of the largest value or the smallest value are likely to come in succession, control information indicating that the reflectance and the color are dependent may be provided for each region.

For example, the decoding method may further include: decoding second attribute information on the second attribute; and converting the first attribute information decoded, based on the second attribute information decoded. Accordingly, the decoding method can reconstruct the original first attribute from the first attribute information for which the data amount has been reduced by converting the first attribute information based on the second attribute information.

For example, the first attribute information may be a difference between the first attribute and the second attribute, and in the converting, the first attribute may be reconstructed from the first attribute information and the second attribute information.

An encoding method according to an aspect of the present disclosure includes: encoding first attribute information on a first attribute of a three-dimensional point; and transmitting the first attribute information encoded and control information. The control information indicates that the first attribute depends on a second attribute of the three-dimensional point. Because the first attribute depends on the second attribute, it may be possible to reduce the data amount of the first attribute information.

For example, the control information may indicate that the first attribute information is a difference between the first attribute and the second attribute. Because the first attribute information is the difference between the first attribute and the second attribute, it may be possible to reduce the data amount of the first attribute information.

For example, the control information may include at least one of offset information or scales information to be applied to the difference. By performing conversion using at least one of the offset information or the scales information, it may be possible to reduce the data amount of the first attribute information.

For example, the at least one of the offset information or the scales information may be provided separately to each of attributes of the three-dimensional point. Accordingly, since the at least one of the offset information or the scales information can be set for each attribute, the data amount of the first attribute information can be reduced.

For example, the first attribute information may be contained in a first component different from a second component in which second attribute information on the second attribute is contained.

For example, a first number of dimensions representing the first component may be different from a second number of dimensions representing the second component. Accordingly, even when the number of dimensions of the first attribute and the second attribute are different, the data amount of the first attribute information can be reduced.

For example, the first attribute information and the second attribute information may indicate a first color and a second color of the three-dimensional point, respectively, and the first color and the second color may each be represented by a plurality of dimensions. Accordingly, by making use of the dependence relationship between the colors of the three-dimensional point which may be correlated, the data amount can be reduced.

For example, the first attribute information and the second attribute information may indicate a color and a reflectance of the three-dimensional point, respectively, and a first number of dimensions representing the color may be three and a second number of dimensions representing the reflectance may be one. Accordingly, by making use of the dependence relationship between the color and the reflectance which may be correlated, the data amount can be reduced.

Furthermore, a decoding device according to an aspect of the present disclosure includes: a processor; and memory. Using the memory, the processor: receives control information; and decodes first attribute information on a first attribute of a three-dimensional point, according to the control information received. The control information received indicates that the first attribute depends on a second attribute of the three-dimensional point.

Furthermore, an encoding device according to an aspect of the present disclosure includes: a processor; and memory. Using the memory, the processor: encodes first attribute information on a first attribute of a three-dimensional point; and transmits the first attribute information encoded and control information. The control information indicates that the first attribute depends on a second attribute of the three-dimensional point.

It is to be noted that these general or specific aspects may be implemented as a system, a method, an integrated circuit, a computer program, or a computer-readable recording medium such as a CD-ROM, or may be implemented as any combination of a system, a method, an integrated circuit, a computer program, and a recording medium.

Hereinafter, embodiments will be specifically described with reference to the drawings. It is to be noted that each of the following embodiments indicate a specific example of the present disclosure. The numerical values, shapes, materials, constituent elements, the arrangement and connection of the constituent elements, steps, the processing order of the steps, etc., indicated in the following embodiments are mere examples, and thus are not intended to limit the present disclosure. Among the constituent elements described in the following embodiments, constituent elements not recited in any one of the independent claims will be described as optional constituent elements.

### EMBODIMENT

Hereinafter, a three-dimensional data encoding device and a three-dimensional data decoding device according to the present embodiment will be described. The three-dimensional data encoding device encodes three-dimensional data to thereby generate a bitstream. The three-dimensional data decoding device decodes the bitstream to thereby generate three-dimensional data.

Three-dimensional data is, for example, three-dimensional point cloud data (also called point cloud data). A point cloud, which is a set of three-dimensional points, represents the three-dimensional shape of an object. The point cloud data includes position information and attribute information on the three-dimensional points. The position information indicates the three-dimensional position of each three-dimensional point. It should be noted that the position information may also be called geometry information. For example, position information is represented using an orthogonal coordinate system or a polar coordinate system.

Attribute information indicates color information, reflectance, infrared information, a normal vector, or time-of-day information, for example. One three-dimensional point may have a single item of attribute information or have a plurality of kinds of attribute information.

The attribute information has different numbers of dimensions in accordance with the kind of the attribute. For example, the color information has three elements (three dimensions), such as RGB or YCbCr. The reflectance has one element (one dimension). The attribute information may have different restrictions, such as different ranges of possible values, different bit depths, or whether the attribute information can assume a negative value or not, in accordance with the kind of the attribute.

Note that a plurality of kinds of attribute information means not only different categories of information, such as color information and reflectance, but also different formats of the same category of information, such as RGB and YCbCr, or different contents of the same category of information, such as color information from different viewpoints. In the following, different kinds of attribute information may be referred to simply as different items of attribute information or the like.

The three-dimensional data is not limited to point cloud data and may be other types of three-dimensional data, such as mesh data. Mesh data (also called three-dimensional mesh data) is a data format used for computer graphics (CG) and represents the three-dimensional shape of an object as a set of surface information items. For example, mesh data includes point cloud information (e.g., vertex information), which may be processed by techniques similar to those for point cloud data.

Conventional three-dimensional data encoding and decoding systems independently encode and decode each of a plurality of kinds of attribute information.

In this embodiment, when encoding a plurality of kinds of attribute information, a three-dimensional data encoding device converts at least one item of attribute information of the plurality of kinds of attribute information using another item of attribute information, and encodes the converted information. In this way, the data amount of the encoded data can be reduced.

For example, point cloud data has first attribute information and second attribute information. The three-dimensional data encoding device generates, for each point, third attribute information, which is difference information, by subtracting the first attribute information from the second attribute information.

The three-dimensional data encoding device generates a bitstream by encoding each of the first attribute information and the third attribute information. Furthermore, the three-dimensional data encoding device generates metadata (control information) that indicates that the third attribute information is information generated by subtracting the first attribute information from the second attribute information, and stores the metadata in the bitstream.

A three-dimensional data decoding device decodes the first attribute information and the third attribute information, and reconstructs the second attribute information by using the decoded first and third attribute information and the metadata.

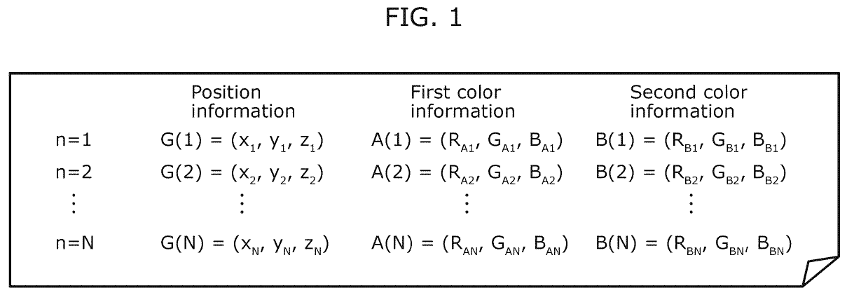

More specifically, when a three-dimensional point is observed from a plurality of viewpoints, for example, the way in which light falls on the three-dimensional point and the way in which the three-dimensional point appears vary with the viewpoint, so that the three-dimensional point has a different color value for each viewpoint. FIG. 1 is a diagram illustrating an example configuration of such point cloud data. As illustrated in FIG. 1, each point has position information, first color information, and second color information. Here, the first color information and the second color information are attribute information and color information corresponding to different viewpoints, for example.

With such a point cloud, the first color information and the second color information are likely to be correlated with each other. Therefore, it may be possible to generate difference information (third attribute information) having a smaller data size than the second color information by subtracting the first color information from the second color information in the manner described above. Therefore, the three-dimensional data encoding device may be able to reduce the data amount of the encoded data by encoding the difference information as the third attribute information instead of the second color information.

In addition, the three-dimensional data encoding device stores, in the bitstream, the metadata that indicates that the third attribute information is the difference between the first color information and the second color information. Thus, the three-dimensional data decoding device can reconstruct the second color information from the first color information and the difference information based on the metadata.

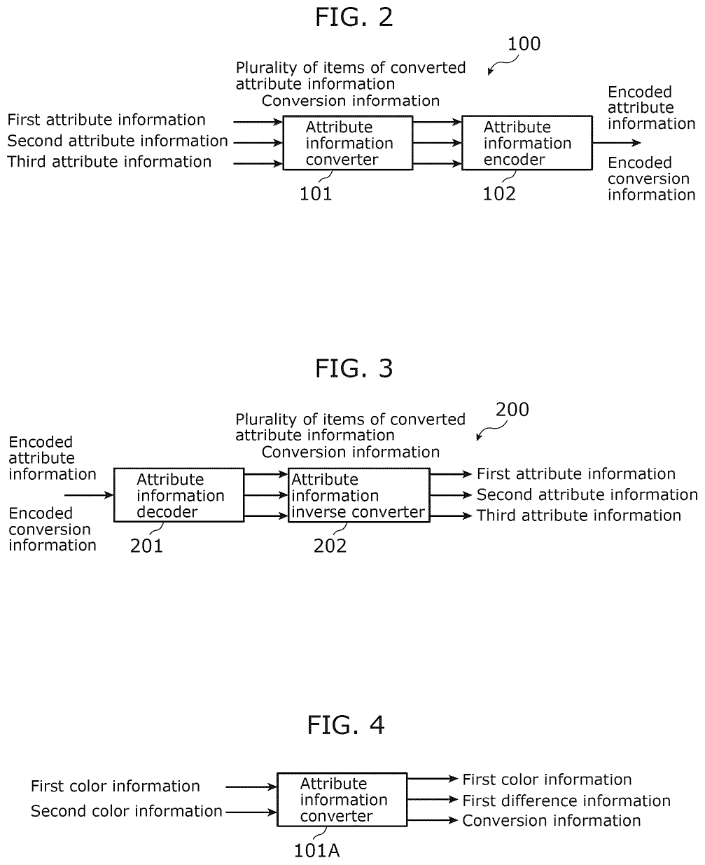

In the following, configurations of a three-dimensional data encoding device and a three-dimensional data decoding device according to this embodiment will be described. FIG. 2 is a block diagram illustrating a configuration of three-dimensional data encoding device 100 according to this embodiment.

Three-dimensional data encoding device 100 encodes a plurality of items of attribute information (first to third attribute information) to generate encoded attribute information and encoded conversion information. Three-dimensional data encoding device 100 includes attribute information converter 101 and attribute information encoder 102. Note that FIG. 2 illustrates only processors involved in the encoding of attribute information. Three-dimensional data encoding device 100 may include other processors, such as a position information encoder that encodes position information.

Attribute information converter 101 converts a plurality of items of attribute information (first attribute information, second attribute information, and third attribute information) into a plurality of items of converted attribute information. That is, attribute information converter 101 converts current attribute information included in a plurality of items of attribute information by using reference attribute information included in the plurality of items of attribute information that is different from the current attribute information. Attribute information converter 101 also generates conversion information that is information about the conversion of the attribute information.

Attribute information converter 101 generates the conversion information based on a correlation between the plurality of items of attribute information. The conversion information is provided in order to reduce the data amount of the converted attribute information. The conversion information includes information that specifies reference attribute information used for the conversion of the current attribute information, for example. The conversion information also includes information that indicates a type of the conversion. The information that indicates a type of the conversion is information that specifies an arithmetic expression for the conversion that uses the current attribute information and the reference attribute information. Note that attribute information converter 101 may generate conversion information based on a dependence relationship between the plurality of items of attribute information, instead of the correlation between the plurality of items of attribute information.

Note that attribute information converter 101 may perform conversion processing using two items of attribute information among the plurality of items of attribute information or may perform conversion processing using three or more items of attribute information among the plurality of items of attribute information. In other words, attribute information converter 101 may convert the current attribute information using two or more items of reference attribute information. That is, attribute information converter 101 may generate one item of converted attribute information using three or more items of attribute information. Furthermore, the plurality of items of converted attribute information output from attribute information converter 101 may or may not include attribute information before conversion.

Attribute information encoder 102 encodes each of the plurality of items of converted attribute information as one attribute component. Attribute information encoder 102 stores the encoded attribute information including a plurality of attribute components in the bitstream. Attribute information encoder 102 also generates encoded conversion information by encoding the conversion information for the plurality of converted attribute information and identification information that indicates a correspondence between the plurality of items of converted attribute information and the plurality of attribute components, and stores the generated encoded conversion information in the bitstream. For example, the identification information is information that indicates a correspondence between each of the plurality of items of converted attribute information and an identification number of an attribute component (attribute component identifier). The identification number is set based on what number attribute component in the bitstream the attribute component is, for example.

FIG. 3 is a block diagram illustrating a configuration of three-dimensional data decoding device 200 according to this embodiment. Three-dimensional data decoding device 200 decodes encoded attribute information and encoded conversion information included in a bitstream to generate a plurality of items of attribute information (first to third attribute information).

Three-dimensional data decoding device 200 includes attribute information decoder 201 and attribute information inverse converter 202. Note that FIG. 3 illustrates only processors involved in the decoding of the attribute information. Three-dimensional data decoding device 200 may include other processors, such as a position information decoder that decodes position information.

Attribute information decoder 201 decodes encoded attribute information to generate a plurality of items of converted attribute information. Attribute information decoder 201 also decodes encoded conversion information to generate conversion information and identification information.

Attribute information inverse converter 202 inverse-converts a plurality of items of converted attribute information based on the conversion information to generate a plurality of items of attribute information (first to third attribute information).

Next, as conversion processing, an example will be described in which difference information between first color information and second color information is generated. FIG. 4 is a diagram illustrating an example of information input to and output from attribute information converter 101A in this case. Attribute information converter 101A is an example of attribute information converter 101 illustrated in FIG. 2.

In this example, for a plurality of points forming a point cloud, attribute information converter 101A does not perform conversion processing on the first color information and outputs the first color information without being processed as first converted attribute information to attribute information encoder 102.

For example, for point n=i, A(i) is output without being processed. Here, A(i) denotes the first color information of point i, and i denotes an identifier of a point (three-dimensional point).

On the other hand, for the plurality of points forming the point cloud, first difference information is calculated by subtracting the first color information from the second color information.

For example, for point n=i, first difference information C(i)=B(i)−A(i)=(R_{Bi}−R_{Ai}, G_{Bi}−G_{Ai}, B_{Bi}−B_{Ai}) is calculated. Here, B(i) denotes the second color information of point i. R_{Ai}, G_{Ai}, and B_{Ai} denote a red component, a green component and a blue component of the first color information, respectively, and R_{Bi}, G_{Bi}, and B_{Bi} denote a red component, a green component, and a blue component of the second color information, respectively. That is, in this example, the first difference information has three dimensions of elements.

Furthermore, attribute information converter 101A generates conversion information that indicates that the first difference information is generated by subtracting a value of the first color information from the second color information.

Furthermore, when generating the first difference information, attribute information converter 101A may perform at least one of scaling processing, which is multiplication or division using scaling value S=(S₀, S₁, S₂), and offset processing, which is addition or subtraction using offset value 0=(O₀, O₁, O₂).

For example, first difference information C(i)=B(i)−A(i)×S+O=(R_{Bi}−R_{Ai}×S₀+O₀, G_{Bi}−G_{Ai}×S₁+O₁, B_{Bi}−B_{Ai}×S₂+O₂) may be calculated.

The value of the difference information can be reduced with the scaling value or offset value, depending on the dispersion of values among attributes or the distribution of mean values or medians of attributes.

When the difference information is a negative value, the difference information can be converted into a positive value by adding offset information. In this case, even when attribute information encoder 102 does not support the encoding of negative values, attribute information encoder 102 can encode the difference information.

Note that attribute information converter 101A may determine the offset value or the scaling value based on preset configuration information, such as bit depth of attribute information. Alternatively, attribute information converter 101A may check for a range of values of attribute information in the point cloud, and determine the offset value or the scaling value based on the range. Alternatively, attribute information converter 101A may check for an offset value or a scaling value with which the value of the difference information is minimized. That is, attribute information converter 101A may calculate difference information for each combination of an offset value and a scaling value, and select a combination of an offset value and a scaling value with which the smallest value of the difference information is obtained.

For example, the offset value or the scaling value is set for each kind of attribute information. Alternatively, a common offset value or scaling value may be used for point clouds of a plurality of frames, or a different offset value or scaling value may be used for each frame. Alternatively, a different offset value or scaling value may be used for each slice, which is a processing unit (group) that is a division of a frame.

Furthermore, when the attribute information has a plurality of dimensions of elements, an offset value or a scaling value may be set for each dimension, or a common offset value or scaling value may be set for all the dimensions.

Furthermore, in the example illustrated in FIG. 4, third color information D may be input to attribute information converter 101A, and difference information E (=D−A) between third color information D and first color information A may be output. In that case, the offset value or scaling value used for calculation of difference information C and the offset value or scaling value used for calculation of difference information E may be the same or different. If a different offset value or scaling value is used for each item of attribute information, it may be possible to further reduce the data amount of the encoded data.

Furthermore, the conversion information including offset information that indicates the offset value or the scaling value is encoded by attribute information encoder 102, and the encoded conversion information is stored in the bitstream.

Furthermore, although FIG. 4 illustrates an example in which difference information between two items of color information is calculated, difference information between different categories of attribute information, such as difference information between color information and reflectance, may be calculated. In that case, the two items of attribute information between which difference information is to be calculated may have different number of dimensions. For example, difference information may be derived by subtracting three-dimensional color information A from one-dimensional reflectance I. In such a case, for example, difference information C(i)=I(i)−A(i)=(Iᵢ−R_{Ai}, Iᵢ−G_{Ai}, Iᵢ−B_{Ai}) is calculated.

Note that one-dimensional reflectance I may be subtracted from three-dimensional color information A. In that case, again, the offset value or the scaling value may be used.

Furthermore, the two items of color information may be of different color matrices, such as RGB and YUV or YCbCr. In that case, the combination of elements used for calculation of the difference can be arbitrary. For example, when calculating the difference between RGB and YUV, the difference between the R component and the Y component may be calculated, or the difference between the R component and the U or V component may be calculated.

Here, the color information and the reflectance may be correlated with each other. In such a case, if difference information between the color information and the reflectance is encoded, the data amount of the encoded data can be reduced, and the encoding efficiency can be improved. Note that the combination of items of attribute information used for calculating the difference is not limited to that described above, and any combination of items of attribute information correlated with each other can be used. The combination of items of attribute information correlated with each other is a combination of color information, reflectance, transmittance, infrared information and the like, for example.

Although an example has been described above in which attribute information of a point cloud of one frame is encoded, the same method can be applied to a case where attribute information of point clouds of a plurality of frames is encoded. Furthermore, the same method can be applied to a case where attribute information of point clouds of a plurality of frames is encoded using temporal prediction. That is, the first color information described above may be a first residual that is the difference between first color information of a current frame and first color information of a reference frame, the second color information described above may be a second residual that is the difference between second color information of the current frame and second color information of the reference frame, and the first difference information described above may be the difference between the first residual and the second residual. Furthermore, data of one frame may be divided into a plurality of items of slice data, and the encoding may be performed on a slice-data basis.

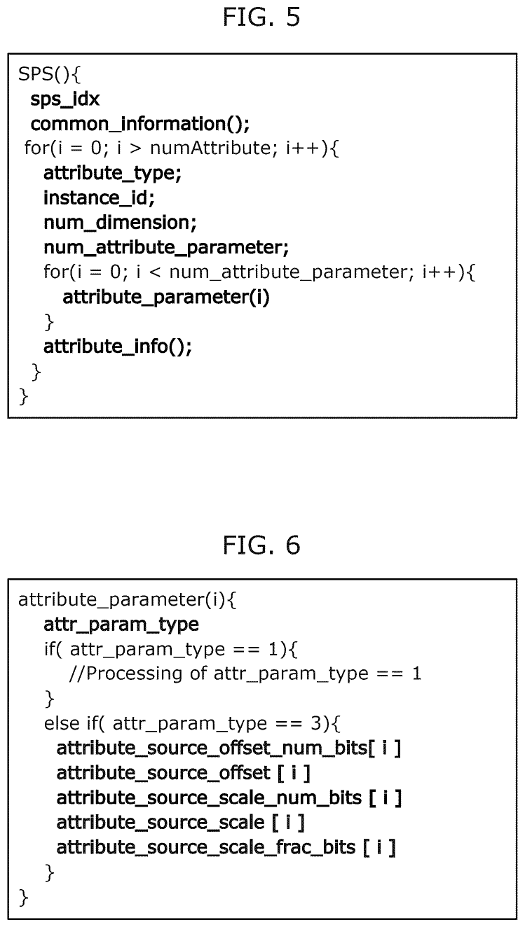

Next, an example syntax involved in the processing described above will be described. FIG. 5 is a diagram illustrating an example syntax of SPS. SPS (Sequence Parameter Set) is metadata (a parameter set) that is common to a plurality of frames.

SPS includes sps_idx, common_information( ), attribute_type, instance_id, num_dimension, num_attribute_parameter, attribute_parameter(i), and attribute_info( ).
sps_idx is an identifier of SPS. common_information( ) is additional information relating to the whole of a sequence. attribute_type, instance_id, num_dimension, num_attribute_parameter, and attribute_parameter(i) are set for each item of attribute information.
attribute_type is an identifier of attribute information. instance_id is an identifier for identifying an instance among instances of the same attribute type. num_dimension indicates the number of dimensions of attribute information. attribute_info( ) is other additional information relating to attribute information.
attribute_parameter( ) includes various kinds of additional information (metadata) for each item of attribute information, and has a general format. num_attribute_parameter indicates the number of items of attribute_parameter.

FIG. 6 is a diagram illustrating an example syntax of attribute_parameter(i). attribute_parameter(i) includes attr_param_type, attribute_source_offset_num_bits, attribute_source_offset, attribute_source_scale_num_bits, attribute_source_scale, and attribute_source_scale_frac_bits.
attr_param_type indicates a type (kind) of attribute_parameter. For example, when attribute_param_type=3, attribute_parameter(i) includes attribute_source_offset_num_bits, attribute_source_offset, attribute_source_scale_num_bits, attribute_source_scale, and attribute_source_scale_frac_bits.

Here, setting num_attribute_parameter at 0 or more and making attribute_param_type=3 valid is equivalent to setting a flag that indicates whether conversion information is included to be valid (which means including conversion information).
attribute_source_offset_num_bits, attribute_source_offset, attribute_source_scale_num_bits, attribute_source_scale, and attribute_source_scale_frac_bits are offset information concerning the offset value and the scaling value.
attribute_source_offset indicates an offset value for restoring the decoded attribute information to the original (source) attribute information.
attribute_source_scale indicates a scaling value for restoring the decoded attribute information to the original attribute information.
attribute_source_offset_num_bits indicates the number of bits of the offset value (attribute_source_offset). Note that when the number of bits indicated by attribute_source_offset_num_bits is 0, it means that the offset processing is not performed (that is, offset=0). That is, attribute_source_offset_num_bits functions as a flag that indicates whether the offset value is indicated or not (the offset processing is performed or not).
attribute_source_scale_num_bits indicates the number of bits of the scaling value (attribute_source_scale). When the number of bits indicated by attribute_source_scale_num_bits is 0, it means that the scaling processing is not performed (that is, scale=1). That is, attribute_source_scale_num_bits functions as a flag that indicates whether the scaling value is indicated or not (the scaling processing is performed or not).
attribute_source_scale_frac_bits indicates the number of bits for representing the value to the right of the decimal point of the scaling value. The scaling value is calculated using attribute_source_scale_frac_bits according to the following equation (Equation 1).

[Math. 1]

$$scale = \frac{attribute\_source \_scale}{( 1 ≪ attribute\_source \_scale \_frac \_bit )} \qquad ( Equation 1 )$$

Next, an example of the encoding of the color information, the difference information and the conversion information will be described. The first color information and the first difference information illustrated in FIG. 4 are each encoded as one attribute component in any encoding method for attribute information, such as LoD based attribute or Transform based attribute.

Note that LoD base attribute is one of conversion methods using LoD (Level of Detail), and is a method of calculating a prediction residual. LoD is also a method of layering three-dimensional points in accordance with position information and a method of layering three-dimensional points in accordance with distances between points (in accordance with the density of points).

Transform based attribute is RAHT (Region Adaptive Hierarchical Transform), for example. RAHT is a method of converting attribute information using position information of a three-dimensional point, in which Haar conversion or the like is applied to attribute information to generate a high-frequency component and a low-frequency component in each layer, and those values are quantized and entropy-encoded, for example.

The first color information is encoded as a three-dimensional first attribute component, and the first difference information is encoded as a three-dimensional second attribute component. Note that the first difference information is attribute information converted and reduced in data amount, as described above.

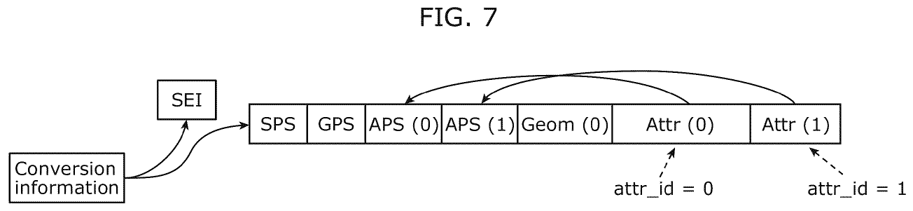

FIG. 7 is a diagram illustrating a configuration of a bitstream. As illustrated in FIG. 7, a bitstream includes SPS, GPS, APS(0), APS(1), Geom(0), Attr(0), and Attr(1).

Encoded data of the first attribute component (first color information) is stored in data unit Attr(0). Attribute component identifier attr_id=0 is stored in a data unit header of Attr(0). Encoded data of the second attribute component (first difference information) is stored in data unit Attr(1). Attribute component identifier attr_id=1 is stored in a data unit header of Attr(1).

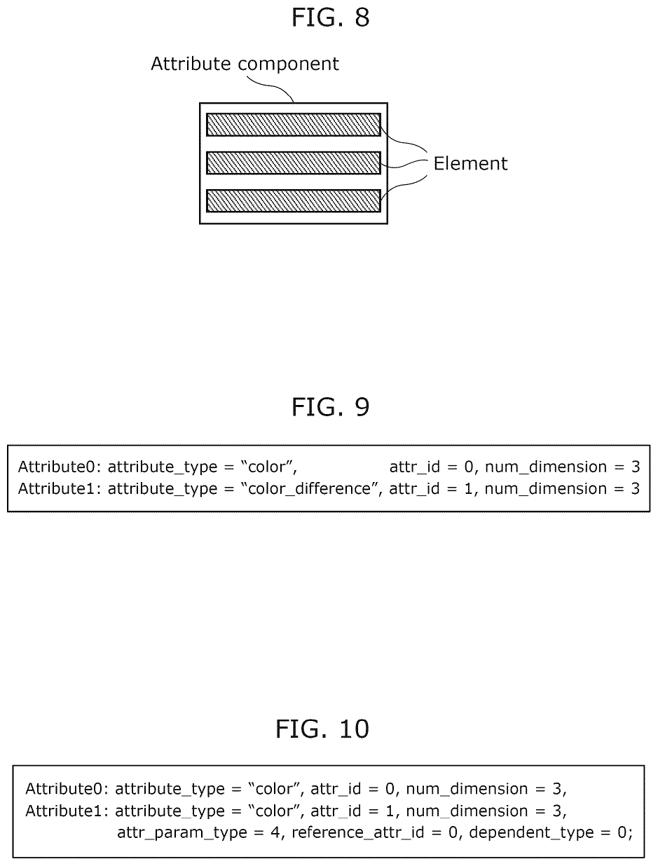

FIG. 8 is a diagram illustrating a configuration of the first attribute component and the second attribute component. As illustrated in FIG. 8, the first attribute component and the second attribute component each have three-dimensions of elements.

Metadata concerning the encoding of the attribute information is stored in APS. APS (Attribute Parameter Set) is metadata (parameter set) concerning encoding of attribute information. APS(0) is metadata concerning the first attribute component, and APS(1) is metadata concerning the second attribute component. For example, APS is metadata that is common to a plurality of frames.

Note that although APS is provided for each attribute component herein, when the same encoding parameter is used for two attribute components, one common APS may be provided for the two attribute components and may be referred to by the two attribute components.

Geom(0) is encoded data of position information. GPS (Geometry Parameter Set) is metadata (parameter set) concerning encoding of position information. For example, GPS is metadata that is common to a plurality of frames.

The conversion information is stored in at least one of SPS and SEI. SEI (Supplemental Enhancement Information) is extension information, in which a parameter (optional parameter) that is not necessarily used in the decoding is stored.

FIG. 9 is a diagram illustrating an example of information stored in SPS. SPS includes an attribute identifier (attribute_type=color) that indicates that the first attribute component (Attribute0) is color information, an attribute component identifier (attr_id=0) of the first attribute component, and the number of dimensions (num_dimension=3) of the first attribute component. SPS also includes an attribute identifier (attribute_type=color difference) that indicates that the second attribute component (Attribute1) is difference information of color information, an attribute component identifier (attr_id=1) of the second attribute component, and the number of dimensions (num_dimension=3) of the second attribute component.

Note that although the attribute identifier of the second attribute component indicates that the attribute component (attribute information) is difference information of color information herein, the attribute identifier of the second attribute component may indicate that the attribute component (attribute information) is converted attribute information or indicate that the attribute component (attribute information) is difference information between two items of attribute information.

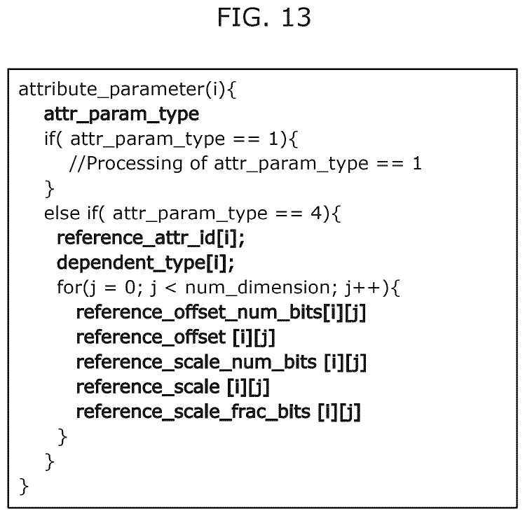

Note that that the attribute component is difference information (or converted attribute information) may be indicated in another manner. For example, the attribute identifier may indicate that the attribute component is color information (attribute_type=color), and that the information is difference information with respect to reference color information may be indicated by using another syntax. FIG. 10 is a diagram illustrating another example of information stored in SPS in that case. Note that FIG. 10 illustrates an example of information in the case where the syntax illustrated in FIG. 13 described later is used. The example illustrated in FIG. 10 differs from the example illustrated in FIG. 9 in the information of the second attribute component (Attribute1). Specifically, the attribute identifier indicates that the second attribute component is color information (attribute_type=color), and information that indicates that the second attribute component is converted information (attr_param_type=4, reference_attr_id=0, dependent_type=0) is added. Note that details of these items of information will be described later with reference to FIG. 13.

Furthermore, it is also possible that the order of items of information of the attribute component indicated in SPS is defined as attr_id, and SPS does not include attr_id. That is, the three-dimensional data decoding device may determine attr_id of the attribute component based on the order of items of information of the attribute component indicated in SPS.

Next, a configuration of attribute information encoder 102 and processing of encoding difference information will be described. Herein, for example, a case will be described in which attribute information encoder 102 is an encoder (LoD based attribute encoder) that performs encoding using LoD.

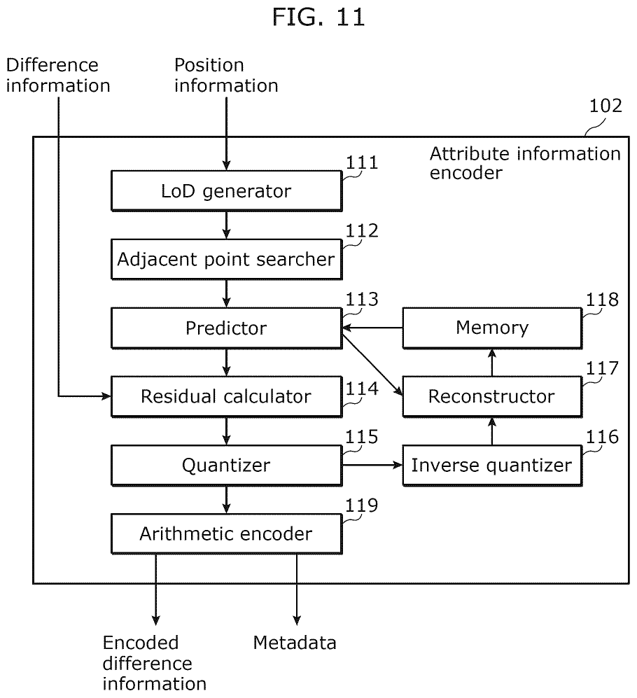

FIG. 11 is a block diagram illustrating a configuration of attribute information encoder 102. Attribute information encoder 102 includes LoD generator 111, adjacent point searcher 112, predictor 113, residual calculator 114, quantizer 115, inverse quantizer 116, reconstructor 117, memory 118, and arithmetic encoder 119.

LoD generator 111 generates a LoD hierarchy using position (geometry) information of a plurality of three-dimensional points. Adjacent point searcher 112 searches for an adjacent three-dimensional point (adjacent point) of a current point to be processed using the LoD generation result and distance information about distances between the three-dimensional points.

Predictor 113 generates a prediction value of difference information. For example, predictor 113 generates a prediction value using encoded difference information of an adjacent point. Residual calculator 114 generates a prediction residual, which is the difference between the difference information and the prediction value.

Quantizer 115 quantizes the prediction residual of the difference information. Inverse quantizer 116 inverse-quantizes the quantized prediction residual. Reconstructor 117 sums the prediction value and the inverse-quantized prediction residual to generate a decoded value, which is the decoded prediction residual of the current point. Memory 118 stores the difference information (decoded values) of the plurality of three-dimensional points encoded and then decoded. The decoded values stored in memory 118 are used for subsequent prediction of a plurality of three-dimensional points by predictor 113.

Arithmetic encoder 119 arithmetically encodes the quantized prediction residual. Note that arithmetic encoder 119 may binarize the quantized prediction residual and arithmetically encode the binarized prediction residual.

Note that a different encoding parameter or quantization value (quantization parameter) may be used depending on whether the difference information is to be encoded or a reference component (reference attribute information) referred to by another attribute component is to be encoded. For example, the reference component may have high importance because the reference component is referred to by another component. Therefore, the reference component may be lossless-compressed, and the difference information may be lossy-compressed. In this way, the encoding efficiency can be improved while reducing the degradation of the information as a whole. That is, the three-dimensional data encoding device may classify a plurality of items of attribute information to be encoded into reference components and difference information, and select an appropriate encoding parameter for each of the reference components and the difference information for encoding. In this way, it is expected that the encoding efficiency can be improved. Note that the reference component may be an attribute component, which is attribute information that is not to be encoded as difference information (that is, attribute information itself that is to be encoded).

Although an example in which difference information is encoded has been described here, the same encoding processing as described above can be applied to a case where other converted attribute information than difference information is encoded or a case where attribute information subjected to no conversion is encoded.

Next, a configuration of attribute information decoder 201 and processing of decoding difference information will be described. Herein, for example, a case will be described in which attribute information decoder 201 is a decoder (LoD based attribute decoder) that performs decoding using LoD.

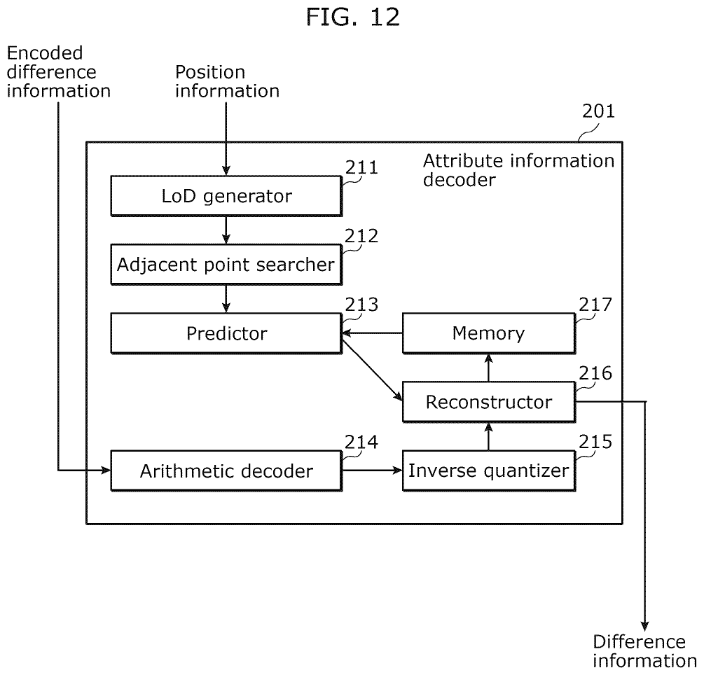

FIG. 12 is a block diagram illustrating a configuration of attribute information decoder 201. Attribute information decoder 201 includes LoD generator 211, adjacent point searcher 212, predictor 213, arithmetic decoder 214, inverse quantizer 215, reconstructor 216, and memory 217.

LoD generator 211 generates LoD using decoded position information of a plurality of three-dimensional points. Adjacent point searcher 212 searches for an adjacent three-dimensional point (adjacent point) of a current point to be processed using the LoD generation result and distance information about distances between the three-dimensional points.

Predictor 213 generates a prediction value of difference information. For example, predictor 213 generates a prediction value using decoded difference information of an adjacent point.

Arithmetic decoder 214 arithmetically decodes the encoded difference information included in the bitstream to generate a prediction residual (quantized prediction residual). Inverse quantizer 215 inverse-quantizes the arithmetically decoded prediction residual (quantized prediction residual). Reconstructor 216 sums the prediction value and the inverse-quantized prediction residual to generate a decoded value. Memory 217 stores the difference information (decoded values) of the plurality of three-dimensional points decoded. The decoded values stored in memory 217 are used for subsequent prediction of a plurality of three-dimensional points by predictor 213.

Although an example in which difference information is decoded has been described here, the same decoding processing as described above can be applied to a case where other converted attribute information than difference information is decoded or a case where attribute information subjected to no conversion is decoded.

Next, a variation of the syntax of the conversion information will be described. FIG. 13 is a diagram illustrating an example syntax of attribute_parameter(i). attribute_parameter illustrated in FIG. 13 is a parameter relating to i-th attribute information and includes conversion information. In this example, the conversion information indicates whether there is a dependence relationship between a plurality of attribute components and indicates the dependence relationship.

Specifically, when attribute_param_type=4, attribute_parameter includes reference_attr_id and dependent_type. These items of information indicate that the attribute component depends on another component (the attribute component is a dependent component).

Here, setting num_attribute_parameter at 0 or more and making attribute_param_type=4 valid can be said as setting a flag that indicates that the attribute component depends on another component to be valid. Furthermore, this can be said as setting a flag that indicates whether the original attribute information can be reconstructed with the attribute component alone to be valid.
reference_attr_id indicates an attribute component identifier of a reference component (a component on which the attribute component depends). dependent_type indicates the way in which the attribute component depends on the reference component. For example, when dependent_type=0, it indicates that the attribute component is difference information with respect to the reference component. Other dependence relationships can also be indicated by using values other than 0.

Note that if it is defined that when attr_param_type=4, it indicates that the attribute component is difference information with respect to the reference component, dependent_type need not be included in the bitstream.
reference_offset_num_bits, reference_offset, reference_scale_num_bits, reference_scale, and reference_scale_frac_bits are offset information concerning the offset value and the scaling value.
reference_offset indicates an offset value for restoring the decoded attribute information to the original (source) attribute information.
reference_scale indicates a scaling value for restoring the decoded attribute information to the original attribute information.
reference_offset_num_bits indicates the number of bits of the offset value (reference_offset). Note that when the number of bits indicated by reference_offset_num_bits is 0, it means that the offset processing is not performed (that is, offset=0). That is, reference_offset_num_bits functions as a flag that indicates whether the offset value is indicated or not (the offset processing is performed or not).
reference_scale_num_bits indicates the number of bits of the scaling value (reference_scale). When the number of bits indicated by reference_scale_num_bits is 0, it means that the scaling processing is not performed (that is, scale=1). That is, reference_scale_num_bits functions as a flag that indicates whether the scaling value is indicated or not (the scaling processing is performed or not).
reference_scale_frac_bits indicates the number of bits for representing the value to the right of the decimal point of the scaling value. S, which is the scaling value, is calculated using reference_scale_frac_bits according to the following equation (Equation 2).

[Math. 2]

$$S = \frac{reference\_scale}{( 1 ≪ reference\_scale \_frac \_bit )} \qquad ( Equation 2 )$$

Using the syntax described above, the example signal of SPS illustrated in FIG. 10 is generated. In this way, the three-dimensional data decoding device can be notified that the attribute component having attr_id=1 is difference information with respect to the attribute component having attr_id=0.

The three-dimensional data decoding device decodes the conversion information and determines, based on the conversion information, that the attribute component having attr_id=1 is difference information with respect to the attribute component having attr_id=0. Then, the three-dimensional data decoding device can reconstruct the original attribute information using difference information of a decoded first attribute component and attribute information of a decoded second attribute component. That is, the three-dimensional data decoding device can uniquely determine the method for reconstructing the attribute information using the decoded attribute component by analyzing reference_attr_id and dependent_type.

For example, Z(i)=(Z₀, Z₁, Z₂), which is the reconstructed attribute information of an i-th point, can be derived according to the following (Equation 3).

[Math. 3]

$$Z ( i ) = \frac{X ( i )}{S} + Y ( i ) - O \qquad ( Equation 3 )$$

Note that X(i)=(X₀, X₁, X₂) is i-th attribute information of the decoded first attribute component, Y(i)=(Y₀, Y₁, Y₂) is i-th attribute information of the decoded second attribute component, O denotes an offset value between attributes, and S denotes a scaling value between attributes.

Furthermore, clipping processing may be performed for limiting the range of values in accordance with the bit precision of the reconstructed data. The bit precision of the reconstructed data may be prescribed to be the same as the bit precision of the reference component, or information indicating the bit precision of the reconstructed data may be included in the metadata, and thereby the three-dimensional data decoding device may be notified of the bit precision.

Although an example has been shown here in which reference_attr_id that indicates the attribute component identifier of the attribute component to be referred to is used, group_id, which indicates a group to be referred to, may be used, for example. Here, one group includes a plurality of attribute components, and a plurality of attribute components are assigned to one group_id. The three-dimensional data encoding device and the three-dimensional data decoding device may refer to any of the plurality of attribute components included in the group referred to. For example, among the plurality of attribute components included in the group referred to, the attribute component having the smallest value of the attribute component identifier may be referred to.

Although a conversion using the difference between two items of color information, scaling, and offset has been described above as an example of the conversion of a plurality of items of attribute information, other methods may be used.

For example, when a three-dimensional point has three or more items of color information, any one item of color information may be used as a reference component, and the same reference component may be referred to by the other attribute components. In that case, by first decoding the reference component, the three-dimensional data decoding device can reconstruct the other attribute components using the data of the decoded reference component. Therefore, the random accessibility can be improved when decoding an arbitrary attribute component.

Furthermore, a plurality of reference components may be set. This may allow the random accessibility to be improved when there is a large number of attribute components.

Furthermore, as the reference component, information converted from the original attribute information may be used, instead of the original attribute information itself. For example, information obtained by quantizing the original attribute information may be used as the reference component. Alternatively, a value obtained by decoding an encoded reference component may be used as the reference component.

Alternatively, a mean value of a plurality of items of attribute information may be calculated, and the calculated mean value may be used as the reference component. In that case, a reference component indicating the mean value and a plurality of attribute components of a plurality of items of difference information are generated. The plurality of attribute components correspond to the plurality of original items of attribute information and each indicate the difference between the reference component and the corresponding original attribute information. In this case, therefore, the number of attribute components increases by 1.

In any case, information, such as dependent_type, that indicates the relevant processing is included in the bitstream, thereby allowing the three-dimensional data decoding device to implement the decoding processing. For example, dependent_type uniquely defines the reconstruction processing to be performed by the three-dimensional data decoding device.

Furthermore, that the data is difference information (or conversion information) may be indicated by a syntax that is different from dependent_type.

Furthermore, an attribute component that cannot be independently decoded without a reference component may be referred to as a dependent component.

Furthermore, when there are a plurality of items of color information for different viewpoints, for example, color information for a predetermined initial viewpoint may be used as a reference component.

Furthermore, it may be prescribed that the number of reference components is limited to 1 and the value of instance_id of the reference component is set at 0. In that case, when the attribute component to be processed is the dependent component, the three-dimensional data encoding device need not add the attribute component identifier of the reference component to the bitstream. In this case, the three-dimensional data decoding device may refer to instance_id and determine that the attribute component having instance_id=0 to be the reference component.

In the above description, as an example, a case has been described where the attribute component to be processed and the reference component are different in kind (type) of the attribute information or number of dimensions. In this case, dependent_type may indicate the reference method. For example, dependent_type may indicate an element that is referred to (an element of the reference component on which an element of the attribute component depends). For example, when the number of dimensions of the reference component is greater than the number of dimensions of the attribute component to be processed, dependent_type may indicate which one of the plurality of elements of the reference component is referred to by each element of the attribute component to be processed. Alternatively, dependent_type may indicate that the attribute component to be processed and the reference component are different in kind of the attribute information or different in the number of dimensions. Note that such information may be indicated by other information than dependent_type included in the bitstream.

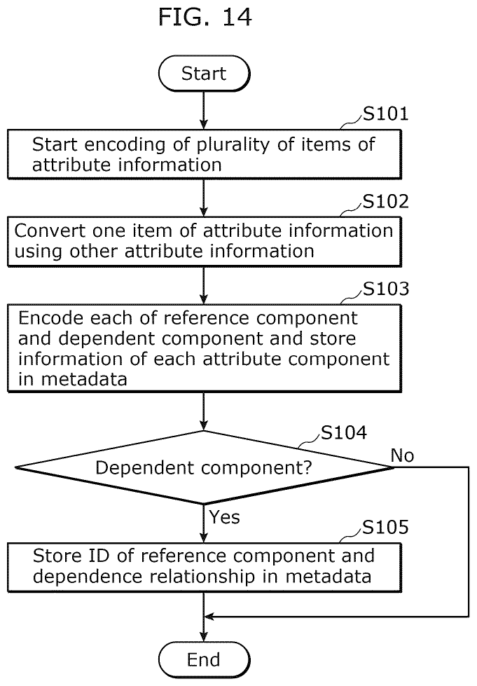

FIG. 14 is a flowchart of encoding processing for attribute information by the three-dimensional data encoding device. The three-dimensional data encoding device first starts encoding of a plurality of items of attribute information (S101). The three-dimensional data encoding device then converts at least one item of attribute information using other attribute information (S102). The three-dimensional data encoding device then encodes each of a reference component and a dependent component in a predetermined manner. The three-dimensional data encoding device also stores information of each attribute component in metadata (S103).

When the attribute component to be processed is a dependent component (Yes in S104), the three-dimensional data encoding device then stores, in the metadata, attribute component identifier (ID) of the reference component of the dependent component, information indicating the dependence relationship or the like (S105).

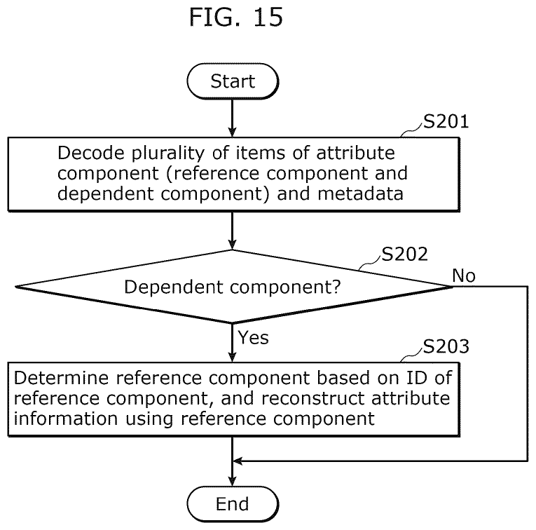

FIG. 15 is a flowchart of decoding processing for attribute information by the three-dimensional data decoding device. The three-dimensional data decoding device first decodes a plurality of attribute components (reference component and dependent component) and metadata from the bitstream (S201).

When the attribute component to be processed is a dependent component (Yes in S202), the three-dimensional data decoding device determines the reference component based on the attribute component identifier (ID) of the reference component described in the metadata included in the bitstream, and reconstructs the attribute information in a predetermined manner using the reference component, the dependent component, and the information of the metadata (S203).

Note that the processing illustrated in FIGS. 14 and 15 may be performed in units of frames or in units of slices.

Although an example in which attribute_parameter is stored in SPS has been shown in the above description, attribute_parameter may be stored in APS or SEI. For example, when the conversion information (dependence relationship) varies with the frame, the conversion information may be stored in SEI of each frame. For example, examples of SEI of each frame include frame_attr_param_SEI.

Note that when the conversion information is indicated in both SPS and SEI of each frame, the three-dimensional data decoding device preferentially uses SEI of each frame.

FIG. 16 is a diagram illustrating an example syntax of frame_attr_param_SEI in this case. In this example, attribute_idx specifies the attribute component to which the conversion information (attribute_parameter) is applied. That is, the conversion information is specified for each attribute component. Note that sps_idx illustrated in FIG. 16 is an index of SPS, and frame_idx is an index of a frame.

Furthermore, common conversion information may be specified for all the attribute components. For example, the conversion information may be included in SEI that is common to all the attribute components, such as attribute_structure_SEI. In that case, the three-dimensional data decoding device can determine the dependence relationship between the plurality of attribute components by analyzing attribute_structure_SEI.

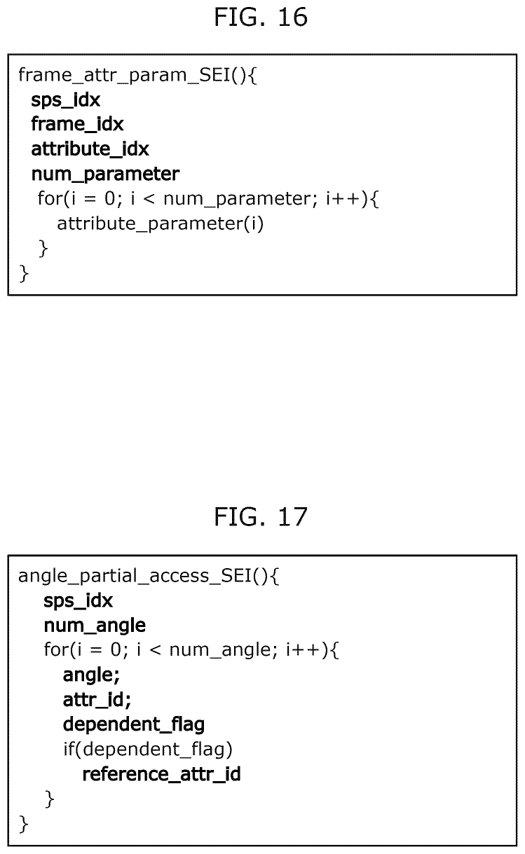

Furthermore, SEI used for partial decoding may be defined. FIG. 17 is a diagram illustrating an example syntax of such SEI (angle_partial_access_SEI).

For example, when different color information is encoded for each viewpoint, SEI includes viewpoint (angle) information and an attribute component identifier (attr_id). Furthermore, for a dependent component (dependent_flag=1), the attribute component identifier (reference_attr_id) of the reference component is indicated.

Note that num_angle illustrated in FIG. 17 indicates the number of viewpoints, and angle indicates a viewpoint. dependent_flag indicates whether the attribute component is a dependent component or not.

Although not illustrated, information indicating the type of the conversion (information indicating that the attribute component is difference information with respect to the reference component, the offset value, or the scaling value, for example) may be included in SEI. Such information may be included in at least one of SPS and SEI.

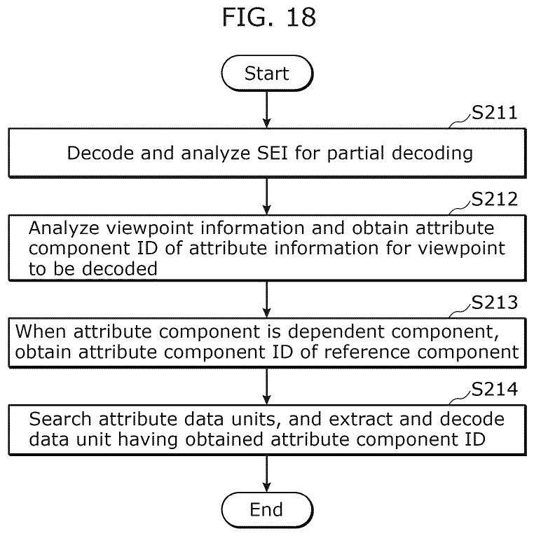

FIG. 18 is a flowchart of decoding processing in the case where the partial decoding is performed. For example, the processing illustrated in FIG. 18 is performed in a system layer.

The three-dimensional data decoding device first decodes and analyzes SEI for partial decoding (S211). The three-dimensional data decoding device then analyzes viewpoint information, and obtains an attribute component identifier (ID) of attribute information for a viewpoint to be decoded (S212). When the attribute component is a dependent component, the three-dimensional data decoding device then obtains the attribute component identifier of the reference component (S213). The three-dimensional data decoding device then searches attribute data units, extracts a data unit having the obtained attribute component identifier, and decodes the extracted data unit (S214).

In this way, the three-dimensional data decoding device obtains, from the bitstream, attribute component identifiers (ID) of attribute components (reference component and dependent component) for a particular viewpoint, and extracts a data unit using the attribute component identifiers.

Note that the extracted data unit need not be decoded, and a bitstream or a file may be reconfigured with the extracted data unit. For example, an edge requests a bitstream or file including attribute information for a particular viewpoint from a server. The server may generate a bitstream or file including extracted attribute information for the particular viewpoint and transmit the bitstream or file to the edge. In this way, the data amount to be transmitted can be reduced, so that it may be possible to reduce the communication time.

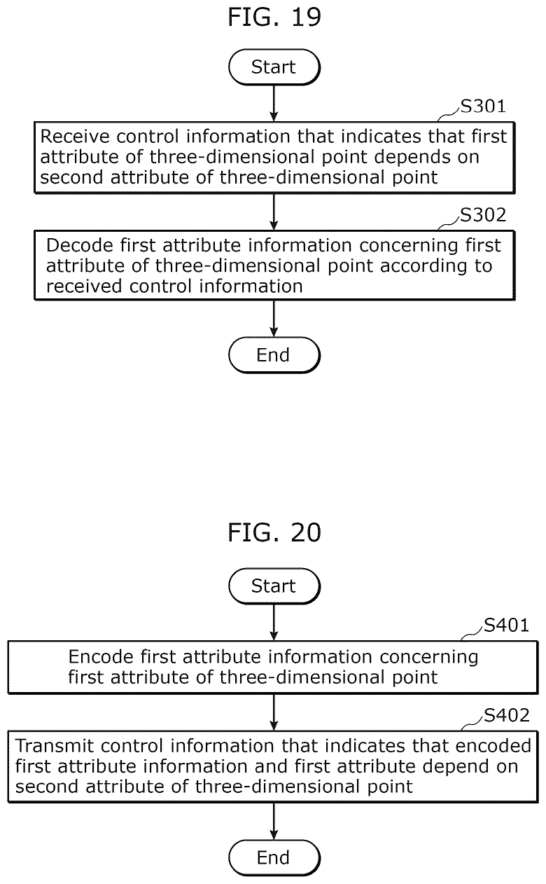

As described above, the decoding device (three-dimensional data decoding device) according to the present embodiment performs the process illustrated in FIG. 19. The decoding device receives control information (for example, conversion information) (S301), and decodes first attribute information on a first attribute of a three-dimensional point, according to the control information received (S302). The control information received indicates that the first attribute is dependent on a second attribute of the three-dimensional point. For example, the first attribute and the second attribute are information before conversion. Furthermore, the first attribute information on the first attribute may be information before conversion or may be converted information.

Because the first attribute depends on the second attribute, it may be possible to reduce the data amount of the first attribute information. A decoding device can appropriately decode encoded data for which the data amount has been reduced in the above manner, using the control information. Furthermore, the amount of data to be handled in the decoding device can be reduced.

For example, the control information indicates that the first attribute information is a difference between the first attribute and the second attribute. Because the first attribute information is the difference between the first attribute and the second attribute, it may be possible to reduce the data amount of the first attribute information. For example, when a plurality of colors are associated with the three-dimensional point as attributes, depending on the region in which the three-dimensional point is present, the plurality of colors become approximately the same. In this case, depending on the region, the first attribute information becomes a value that is close to 0, and the data amount is reduced. Therefore, control information may be provided for each region.

For example, the control information includes at least one of offset information (for example, offset value) or scales information (scale value) to be applied to the difference. By performing conversion using at least one of the offset information or the scales information, it may be possible to reduce the data amount of the first attribute information. For example, when the first attribute and the second attribute satisfy a linear function relationship, the value of the first attribute information becomes a value that is close to 0.

For example, the at least one of the offset information or the scales information is provided separately to each of a plurality of attributes of the three-dimensional point. Accordingly, since the at least one of the offset information or the scales information can be set for each attribute, the data amount of the first attribute information can be reduced.

For example, the first attribute information is contained in a first component different from a second component in which second attribute information on the second attribute is contained. The second attribute information on the second attribute may be information before conversion or may be converted information.

For example, a first number of dimensions representing the first component is different from a second number of dimensions representing the second component. Accordingly, even when the number of dimensions of the first attribute and the second attribute are different, the data amount of the first attribute information can be reduced.

Here, a component is a unit of storage of information, and a dimension represents information. T dimensions are, for example, the R component, the G component, and the B component in the RGB format. However, the dimensions are not limited to this, and may be components of a YUV format or CMYK format, or may be components of other formats.

For example, the first attribute information and the second attribute information indicate a first color and a second color of the three-dimensional point, respectively, and the first color and the second color are each represented by a plurality of dimensions. Accordingly, by making use of the dependence relationship between the colors of the three-dimensional point which may be correlated, the data amount can be reduced.

For example, the first attribute information and the second attribute information indicate a color and a reflectance of the three-dimensional point, respectively, and a first number of dimensions representing the color is three and a second number of dimensions representing the reflectance is one. Accordingly, by making use of the dependence relationship between the color and the reflectance which may be correlated, the data amount can be reduced. For example, when the reflectance is substantially equal to the smallest value, the color of the three-dimensional point having such reflectance is close to black, and when the reflectance is substantially equal to the largest value, the color of the three-dimensional point having such reflectance is close to white. In view of this, by establishing beforehand between the encoding device and the decoding device an agreement that the first attribute information is to be decoded into information indicating black or white depending on the reflectance, it may be possible to reduce the data amount of the first attribute information.

Furthermore, since positions with a reflectance of the largest value or the smallest value are likely to come in succession, control information indicating that the reflectance and the color are dependent may be provided for each region.

For example, the decoding apparatus further decodes second attribute information on the second attribute; and converts the first attribute information decoded, based on the second attribute information decoded. Accordingly, the decoding device can reconstruct the original first attribute from the first attribute information for which the data amount has been reduced by converting the first attribute information based on the second attribute information.

For example, the first attribute information is a difference between the first attribute and the second attribute, and the decoding device reconstructs the first attribute from the first attribute information and the second attribute information.

For example, the decoding device includes a processor and memory, and the processor performs the above-described processes using the memory.

Furthermore, the encoding device (three-dimensional data encoding device) according to the present embodiment performs the process illustrated in FIG. 20. The encoding device encodes first attribute information on a first attribute of a three-dimensional point (S401), and transmits the first attribute information encoded and control information (S402). The control information indicates that the first attribute depends on a second attribute of the three-dimensional point. Furthermore, the first attribute information on the first attribute may be information before conversion or may be converted information. Because the first attribute depends on the second attribute, it may be possible to reduce the data amount of the first attribute information.

For example, the control information indicates that the first attribute information is a difference between the first attribute and the second attribute. Because the first attribute information is the difference between the first attribute and the second attribute, it may be possible to reduce the data amount of the first attribute information.

For example, the control information includes at least one of offset information (for example, offset value) or scales information (scale value) to be applied to the difference. By performing conversion using at least one of the offset information or the scales information, it may be possible to reduce the data amount of the first attribute information.

For example, the at least one of the offset information or the scales information is provided separately to each of a plurality of attributes of the three-dimensional point. Accordingly, since the at least one of the offset information or the scales information can be set for each attribute, the data amount of the first attribute information can be reduced.

For example, the first attribute information is contained in a first component different from a second component in which second attribute information on the second attribute is contained. The second attribute information on the second attribute may be information before conversion or may be converted information.

For example, a first number of dimensions representing the first component is different from a second number of dimensions representing the second component. Accordingly, even when the number of dimensions of the first attribute and the second attribute are different, the data amount of the first attribute information can be reduced.

For example, the first attribute information and the second attribute information indicate a first color and a second color of the three-dimensional point, respectively, and the first color and the second color are each represented by a plurality of dimensions. Accordingly, by making use of the dependence relationship between the colors of the three-dimensional point which may be correlated, the data amount can be reduced.

For example, the first attribute information and the second attribute information indicate a color and a reflectance of the three-dimensional point, respectively, and a first number of dimensions representing the color is three and a second number of dimensions representing the reflectance is one. Accordingly, by making use of the dependence relationship between the color and the reflectance which may be correlated, the data amount can be reduced.

For example, the decoding device includes a processor and memory, and the processor performs the above-described processes using the memory.

For example, a decoding method includes decoding first attribute information of at least one three-dimensional point, based on information indicating whether the first attribute information depends on second attribute information of the at least one three-dimensional point. Because the first attribute information depends on the second attribute information, it may be possible to reduce the data amount of the first attribute information. A decoding device can appropriately decode encoded data for which the data amount has been reduced in the above manner, using the control information. Furthermore, the amount of data to be handled in the decoding device can be reduced.

For example, a decoding method includes decoding information on attributes of three-dimensional points, the attributes including a first attribute. The information includes first information on the first attribute, and the first attribute indicates a difference between a reference error and another attribute. Because the first attribute is the difference between the reference attribute and the other attribute, it may be possible to reduce the data amount of the first information.

For example, the reference attribute is a second attribute and the other attribute is the first attribute before conversion. For example, a decoding method includes decoding first attribute information and second attribute information of at least one three-dimensional point. The first attribute information and the second attribute information are each generated based on a plurality of attributes of the at least one three-dimensional point. Because the first attribute information and the second attribute information are each generated based on a plurality of attributes, it may be possible to reduce the data amount of the first attribute information and the second attribute information.

For example, a decoding method includes decoding information on attributes of at least one three-dimensional point, based on conversion information. The conversion information is used to decode only part of the information on the attributes. Accordingly, since conversion can be performed selectively on the attributes, the data amount of encoded data can be efficiently reduced.

For example, the conversion information is generated based on correlation among at least two of the attributes. By performing conversion using the correlation of the attributes, it may be possible to reduce the data amount of encoded data.

For example, the conversion information includes offset information applied to at least a part of the attributes. By performing conversion using an offset value, it may be possible to reduce the data amount of encoded data.

For example, the conversion information includes information indicating a converted attribute. Accordingly, since conversion can be performed selectively on attributes, the data amount of encoded data can be efficiently reduced.

For example, an encoding method includes encoding first attribute information of at least one three-dimensional point, based on information indicating whether the first attribute information depends on second attribute information of the at least one three-dimensional point. Because the first attribute information depends on the second attribute information, it may be possible to reduce the data amount of the first attribute information

For example, an encoding method includes encoding information on attributes of three-dimensional points, the attributes including a first attribute. The information includes first information on the first attribute, and the first attribute indicates a difference between a reference error and another attribute. Because the first attribute is the difference between the reference attribute and the other attribute, it may be possible to reduce the data amount of the first information.

For example, the reference attribute is a second attribute and the other attribute is the first attribute before conversion. For example, an encoding method includes encoding first attribute information and second attribute information of at least one three-dimensional point. The first attribute information and the second attribute information are each generated based on a plurality of attributes of the at least one three-dimensional point. Because the first attribute information and the second attribute information are each generated based on a plurality of attributes, it may be possible to reduce the data amount of the first attribute information and the second attribute information.

For example, an encoding method includes encoding information on attributes of at least one three-dimensional point, based on conversion information. The conversion information is used to encode only part of the information on the attributes. Accordingly, since conversion can be performed selectively on the attributes, the data amount of encoded data can be efficiently reduced.

For example, the conversion information is generated based on correlation among at least two of the attributes. By performing conversion using the correlation of the attributes, it may be possible to reduce the data amount of encoded data.

For example, the conversion information includes offset information applied to at least a part of the attributes. By performing conversion using an offset value, it may be possible to reduce the data amount of encoded data.

For example, the conversion information includes information indicating a converted attribute. Accordingly, since conversion can be performed selectively on attributes, the data amount of encoded data can be efficiently reduced.

For example, a conversion method (encoding method) includes converting first attribute information of at least one three-dimensional point based on second attribute information of the at least one three-dimensional point, and outputting the first attribute information converted to a decoding device. Accordingly, by converting the first attribute information based on the second attribute information, the data amount of the first attribute information converted can be reduced.

For example, the conversion method further includes converting the second attribute information, and outputting the second attribute information converted to the decoding device. Accordingly, the data amount of the second attribute information converted can be reduced.

For example, a conversion method (encoding method) includes generating information on a difference between a reference attribute and another attribute of a three-dimensional point, and outputting the information and information of the reference attribute to a decoding device. Accordingly, by generating information on the difference between the reference attribute and the other attribute, the data amount of the information can be reduced.

For example, a conversion method (encoding method) includes converting attribute information of a three-dimensional point, based on dependency information indicating dependency of the attribute information on another attribute information of the three-dimensional point, and outputting the dependence information and the attribute information converted to a decoding device. Accordingly, by converting the attribute information based on the dependence information, the data amount of the attribute information can be reduced.

For example, an inverse conversion method (decoding method) includes converting (inverse-converting) first attribute information of at least one three-dimensional point based on second attribute information of the at least one three-dimensional point.

Accordingly, the inverse conversion method can reconstruct the original first attribute information from the first attribute information for which the data amount has been reduced by converting the first attribute information based on the second attribute information.

For example, the inverse conversion method further includes converting (inverse-converting) the second attribute information.

Accordingly, the inverse conversion method can reconstruct the original second attribute information from the second attribute information for which the data amount has been reduced.

For example, the inverse conversion method (decoding method) includes receiving information on a difference between a reference attribute and another attribute of a three-dimensional point and information of the reference information, and reconstructing the other attribute from the information and the information of the reference attribute. Accordingly, the original data can be reconstructed from the information for which the data amount has been reduced by generating information on the difference between the reference attribute and the other attribute.

Furthermore, the inverse conversion method (decoding method) includes receiving attribute information of a three-dimensional point and dependency information indicating dependency of the attribute information on another attribute information of the three-dimensional point, and converting (inverse-converting) the attribute information based on the dependency information. Accordingly, the original attribute information can be reconstructed from the attribute information for which the data amount has been reduced by converting the attribute information based on the dependency information.

A three-dimensional data encoding device (encoding device), a three-dimensional data decoding device (decoding device), and the like, according to embodiments of the present disclosure and variations of the embodiments have been described above, but the present disclosure is not limited to these embodiments, etc.

Note that each of the processors included in the three-dimensional data encoding device, the three-dimensional data decoding device, and the like, according to the above embodiments is typically implemented as a large-scale integrated (LSI) circuit, which is an integrated circuit (IC). These may take the form of individual chips, or may be partially or entirely packaged into a single chip.

Such IC is not limited to an LSI, and thus may be implemented as a dedicated circuit or a general-purpose processor. Alternatively, a field programmable gate array (FPGA) that allows for programming after the manufacture of an LSI, or a reconfigurable processor that allows for reconfiguration of the connection and the setting of circuit cells inside an LSI may be employed.

Moreover, in the above embodiments, the constituent elements may be implemented as dedicated hardware or may be realized by executing a software program suited to such constituent elements. Alternatively, the constituent elements may be implemented by a program executor such as a CPU or a processor reading out and executing the software program recorded in a recording medium such as a hard disk or a semiconductor memory.

The present disclosure may also be implemented as a three-dimensional data encoding method (encoding method), a three-dimensional data decoding method (decoding method), or the like executed by the three-dimensional data encoding device (encoding device), the three-dimensional data decoding device (decoding device), and the like.

Also, the divisions of the functional blocks shown in the block diagrams are mere examples, and thus a plurality of functional blocks may be implemented as a single functional block, or a single functional block may be divided into a plurality of functional blocks, or one or more functions may be moved to another functional block. Also, the functions of a plurality of functional blocks having similar functions may be processed by single hardware or software in a parallelized or time-divided manner.

Also, the processing order of executing the steps shown in the flowcharts is a mere illustration for specifically describing the present disclosure, and thus may be an order other than the shown order. Also, one or more of the steps may be executed simultaneously (in parallel) with another step.

A three-dimensional data encoding device, a three-dimensional data decoding device, and the like, according to one or more aspects have been described above based on the embodiments, but the present disclosure is not limited to these embodiments. The one or more aspects may thus include forms achieved by making various modifications to the above embodiments that can be conceived by those skilled in the art, as well forms achieved by combining constituent elements in different embodiments, without materially departing from the spirit of the present disclosure.

### INDUSTRIAL APPLICABILITY

The present disclosure is applicable to a three-dimensional data encoding device and a three-dimensional data decoding device.

1. A decoding method comprising:
receiving control information; and
decoding first attribute information on a first attribute of a three-dimensional point, according to the control information received, wherein
the control information received indicates that the first attribute depends on a second attribute of the three-dimensional point.

2. The decoding method according to claim 1, wherein
the control information indicates that the first attribute information is a difference between the first attribute and the second attribute.

3. The decoding method according to claim 2, wherein
the control information includes at least one of offset information or scales information to be applied to the difference.

4. The decoding method according to claim 3, wherein
the at least one of the offset information or the scales information is provided separately to each of a plurality of attribute information of the three-dimensional point.

5. The decoding method according to claim 1, wherein
the first attribute information is contained in a first component different from a second component in which second attribute information on the second attribute is contained.

6. The decoding method according to claim 5, wherein
a first number of dimensions representing the first component is different from a second number of dimensions representing the second component.

7. The decoding method according to claim 5, wherein
the control information includes an identifier of the second component, as information indicating the second attribute on which the first attribute depends.

8. The decoding method according to claim 1, wherein
the first attribute information and the second attribute information indicate a first color and a second color of the three-dimensional point, respectively, and
the first color and the second color are each represented by a plurality of dimensions.

9. The decoding method according to claim 1, wherein
the first attribute information and the second attribute information indicate a color and a reflectance of the three-dimensional point, respectively, and
a first number of dimensions representing the color is three and a second number of dimensions representing the reflectance is one.

10. The decoding method according to claim 1, further comprising:
decoding second attribute information on the second attribute; and
converting the first attribute information decoded, based on the second attribute information decoded.

11. The decoding method according to claim 10, wherein
the first attribute information is a difference between the first attribute and the second attribute, and
in the converting, the first attribute is reconstructed from the first attribute information and the second attribute information.

12. The decoding method according to claim 1, wherein
the first attribute and the second attribute are correlated.

13. The decoding method according to claim 1, wherein
in the decoding of the first attribute information, the first attribute information is obtained by decoding encoded data, and
the encoded data is generated using the first attribute and the second attribute.

14. An encoding method comprising:
encoding first attribute information on a first attribute of a three-dimensional point; and
transmitting the first attribute information encoded and control information, wherein
the control information indicates that the first attribute depends on a second attribute of the three-dimensional point.

15. The encoding method according to claim 14, wherein
the control information indicates that the first attribute information is a difference between the first attribute and the second attribute.

16. The encoding method according to claim 15, wherein
the control information includes at least one of offset information or scales information to be applied to the difference.

17. The encoding method according to claim 16, wherein
the at least one of the offset information or the scales information is provided separately to each of attributes of the three-dimensional point.

18. The encoding method according to claim 14, wherein
the first attribute information is contained in a first component different from a second component in which second attribute information on the second attribute is contained.

19. The encoding method according to claim 18, wherein
a first number of dimensions representing the first component is different from a second number of dimensions representing the second component.

20. The encoding method according to claim 14, wherein
the first attribute information and the second attribute information indicate a first color and a second color of the three-dimensional point, respectively, and
the first color and the second color are each represented by a plurality of dimensions.

21. The encoding method according to claim 14, wherein
the first attribute information and the second attribute information indicate a color and a reflectance of the three-dimensional point, respectively, and
a first number of dimensions representing the color is three and a second number of dimensions representing the reflectance is one.

22. A decoding device comprising:
a processor; and
memory, wherein
using the memory, the processor:
receives control information; and
decodes first attribute information on a first attribute of a three-dimensional point, according to the control information received, and
the control information received indicates that the first attribute depends on a second attribute of the three-dimensional point.

23. An encoding device comprising:
a processor; and
memory, wherein
using the memory, the processor:
encodes first attribute information on a first attribute of a three-dimensional point; and
transmits the first attribute information encoded and control information, and
the control information indicates that the first attribute depends on a second attribute of the three-dimensional point.
